(19) United States
(12) Patent Application Publication
(10) Pub. No.: US 2008/0114823 A1
(43) Pub. Date: May 15, 2008

(54) Method of transferring data from a first device to a second device

(75) Inventors: Haifeng Wang, Shanghai (CN); Jorma Lilleberg, Oulu (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/598,605

(22) Filed: Nov. 13, 2006

(51) Int. Cl. G06F 17/14

(52) U.S. Cl. 708/409

(57) ABSTRACT

A method of transferring data from a first device to a second device, the method including receiving information at the second device; and converting first data, from the first device, from the time domain to the frequency domain using butterfly computations to produce second data, wherein the butterfly computations used are a subset of the available butterfly computations and are selected using the received information.

### FIELD OF THE INVENTION

Embodiments of the present invention relate to a method of transferring data from a first device to a second device. In particular, they relate to a method of transferring data from a first device to a second device in an OFDMA-TDMA system.

### BACKGROUND TO THE INVENTION

In order that a communication channel between electronic devices is used and shared efficiently, various methods such as TDMA, FDMA, CDMA and OFDMA-TDMA may be used.

In an OFDMA-TDMA system, communication between electronic devices occurs within predetermined time slots. In any given time slot, one or more sub-carriers may be allocated to one or more of the electronic devices so that the available frequency bandwidth may be shared between a plurality of electronic devices. The sub-carriers allocated to a given electronic device may be different for different time slots.

In order to transfer data between electronic devices, it is necessary at the transmitting electronic device to first modulate the data with a plurality of sub-carriers.

Inverse fast Fourier transforms are then performed to convert the data from the frequency domain to the time domain so that it may be modulated with a carrier wave. Similarly, at the receiving electronic device it is necessary to perform fast Fourier transforms to convert the data (modulated with the plurality of sub-carriers) from the time domain to the frequency domain so that it may be further processed by a processor of the receiving electronic device.

One problem associated with a system such as an OFDMA-TDMA system is that the receiving device has no knowledge of which sub-carriers it should perform fast Fourier transforms on in a given time slot. Consequently, the receiving device performs fast Fourier transforms on all of the received data even if it does not contain any information for the receiving device. This may result in inefficient power consumption since the receiving device may have to perform a larger number of calculations than necessary.

It would therefore be desirable to provide an alternative system.

### BRIEF DESCRIPTION OF THE INVENTION

According to one embodiment of the invention there is provided a method of transferring data from a first device to a second device, the method comprising: receiving information at the second device; and converting first data, from the first device, from the time domain to the frequency domain using butterfly computations to produce second data, wherein the butterfly computations used are a subset of the available butterfly computations and are selected using the received information.

The method may be of transferring data from a first device to a second device in an OFDMA-TDMA system.

A butterfly computation may include a first input, a second input and an output. The output may be equal to a weighted sum of the first input and the second input. The weighted sum may be equal to the addition of the second input multiplied by a negative weighting factor to the first input. The weighted sum may be equal to the addition of the second input multiplied by a positive weighting factor to the first input. Each of the selected butterfly computations may have a different combination of first input, second input and weighting factor.

The available butterfly computations may be arranged into a plurality of parallel layers arranged sequentially. Each layer may include a plurality of butterfly computations. The first input and the second input of a butterfly computation in a layer may be each arranged to receive outputs from different butterfly computations in a preceding layer in the sequence of layers. The inputs to the butterfly computations in the initial layer of the sequence of layers may be the first data. The outputs to the butterfly computations in the final layer of the sequence of layers may be the second data. The selection of butterfly computations used in each layer of the sequence of layers may be dependent on the received information.

The information may be for defining a subset of sub-carriers, within a plurality of sub-carriers, which are allocated to a communication channel between the first device and the second device. The number of sub-carriers in the subset of sub-carriers may be equal to a power of two. Each sub-carrier of the subset may be separated from an adjacent sub-carrier of the subset by substantially the same bandwidth. The number of data items in the second data may be equal to the number of sub-carriers in the allocated subset of sub-carriers.

The first device may determine the subset of sub-carriers and transmit the information for defining the subset of sub-carriers to the second device. The first device may determine the subset of sub-carriers by using data obtained by measuring the channel condition and/or quality of service and/or data rate of each channel between the first device and the second device.

The conversion of the first data from the time domain to the frequency domain may occur at the second device.

The method may further comprise receiving a signal, modulated by the first device with information destined for the second device. The method may also further comprise demodulating the received modulated signal to produce a signal. The method may also further comprise separating the signal into data items to form the first data. The method may also further comprise demodulating the second data to produce third data corresponding to the information destined for the second device.

According to another embodiment of the invention there is provided a device comprising: a receiver for receiving information; and a processor for converting first data, from a further device, from the time domain to the frequency domain using butterfly computations to produce second data, wherein the butterfly computations used are a subset of the available butterfly computations and are selected using the received information.

A butterfly computation may include a first input, a second input and an output. The output may be equal to a weighted sum of the first input and the second input. The weighted sum may be equal to the addition of the second input multiplied by a negative weighting factor to the first input. The weighted sum may be equal to the addition of the second input multiplied by a positive weighting factor to the first input. Each of the selected butterfly computations may have a different combination of first input, second input and weighting factor.

The available butterfly computations may be arranged into a plurality of parallel layers arranged sequentially. Each layer may include a plurality of butterfly computations. The first input and the second input of a butterfly computation in a layer may each be arranged to receive outputs from different butterfly computations in a preceding layer in the sequence of layers. The inputs to the butterfly computations in the initial layer of the sequence of layers may be the first data. The outputs to the butterfly computations in the final layer of the sequence of layers may be the second data. The selection of butterfly computations used in each layer of the sequence of layers may be dependent on the received information.

The received information may be for defining a subset of sub-carriers, within a plurality of sub-carriers, which are allocated to a communication channel between the device and the further device. The number of sub-carriers in the subset of sub-carriers may be equal to a power of two. Each sub-carrier of the subset may be separated from an adjacent sub-carrier of the subset by substantially the same bandwidth. The number of data items in the second data may be equal to the number of sub-carriers in the allocated subset of sub-carriers.

The further device may determine the subset of sub-carriers. The further device may transmit the information for defining the subset of sub-carriers to the device. The further device may determine the subset of sub-carriers by using data obtained by measuring the channel condition and/or quality of service and/or data rate of each channel between the further device and the device.

The receiver may be arranged to receive a signal, modulated by the further device with information destined for the device. The receiver may be arranged to demodulate the received modulated signal to produce a signal. The receiver may be arranged to separate the signal into data items to form the first data. The processor may be arranged to demodulate the second data to produce third data corresponding to the information destined for the device.

According to a further embodiment of the invention there is provided a system comprising: a first device for transmitting information; a second device for receiving the information, wherein the second device is arranged to convert first data, from the first device, from the time domain to the frequency domain using butterfly computations to produce second data, wherein the butterfly computations used are a subset of the available butterfly computations and are selected using the received information.

The system may be an OFDMA-TDMA system.

According to another embodiment of the invention there is provided a computer program comprising program instructions for converting data from the time domain to the frequency domain and comprising means for converting first data from the time domain to the frequency domain using butterfly computations to produce second data, wherein the butterfly computations used are a subset of the available butterfly computations and are selected using received information.

According to a further embodiment of the invention there is provided a physical entity embodying the computer program as described above.

According to another embodiment of the invention there is provided an electromagnetic carrier signal carrying the computer program as described above.

According to a further embodiment of the invention there is provided a computer program comprising program instructions for causing a computer to perform the method described above.

According to another embodiment of the invention there is provided a computer program comprising program instructions which, when loaded into a computer, constitute the processor described above.

### BRIEF DESCRIPTION OF THE DRAWINGS

For a better understanding of the present invention reference will now be made by way of example only to the accompanying drawings in which:

FIG. 1 illustrates a schematic diagram of one embodiment of a system;

FIG. 2 illustrates a graph of how frequency channels and time slots are divided in an OFDMA-TDMA system;

FIG. 3 illustrates a flow diagram of data at a transmitter in an OFDMA-TDMA system according to the prior art;

FIG. 4 illustrates a flow diagram of data at a receiver in an OFDMA-TDMA system according to the prior art;

FIG. 5 illustrates a diagram of a ‘butterfly’;

FIG. 6 illustrates a schematic flow diagram of data at a receiver in a system according to one embodiment of the present invention;

FIG. 7 illustrates a plurality of butterfly computations performed at a receiver in a system according to a first embodiment of the present invention;

FIG. 8 illustrates a plurality of butterfly computations performed at a receiver in a system according to a second embodiment of the present invention; and

FIG. 9 illustrates a plurality of butterfly computations performed at a receiver in a system according to a third embodiment of the present invention.

### DETAILED DESCRIPTION OF EMBODIMENTS OF THE INVENTION

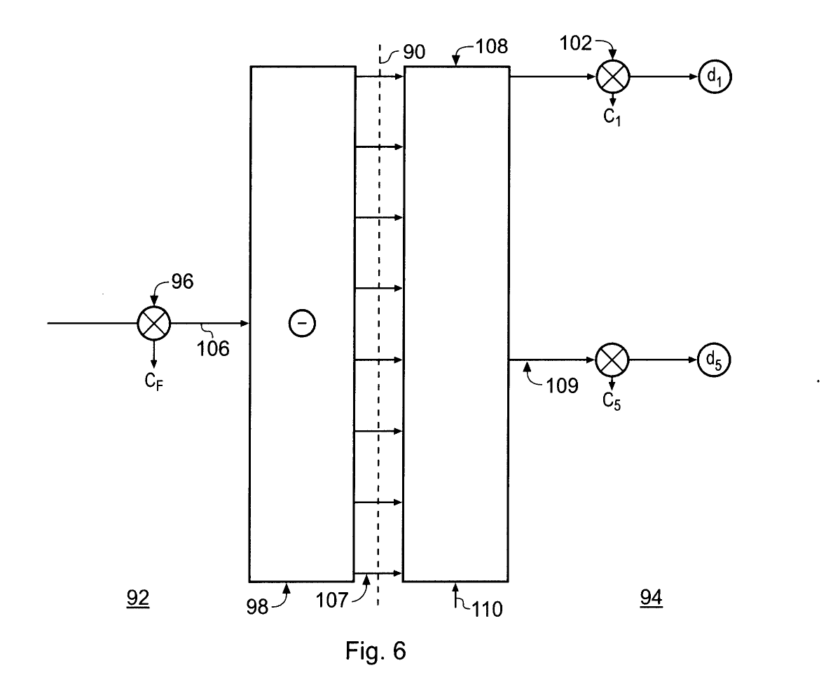

FIGS. 6 to 9 illustrate a method of transferring data from a first device 12 to a second device 14 in a system 10, the method comprising: receiving information 110 at the second device 14; and converting first data 107, from the first device 12, from the time domain to the frequency domain using butterfly computations to produce second data 109, wherein the butterfly computations used are a subset of the available butterfly computations and are selected using the received information 110.

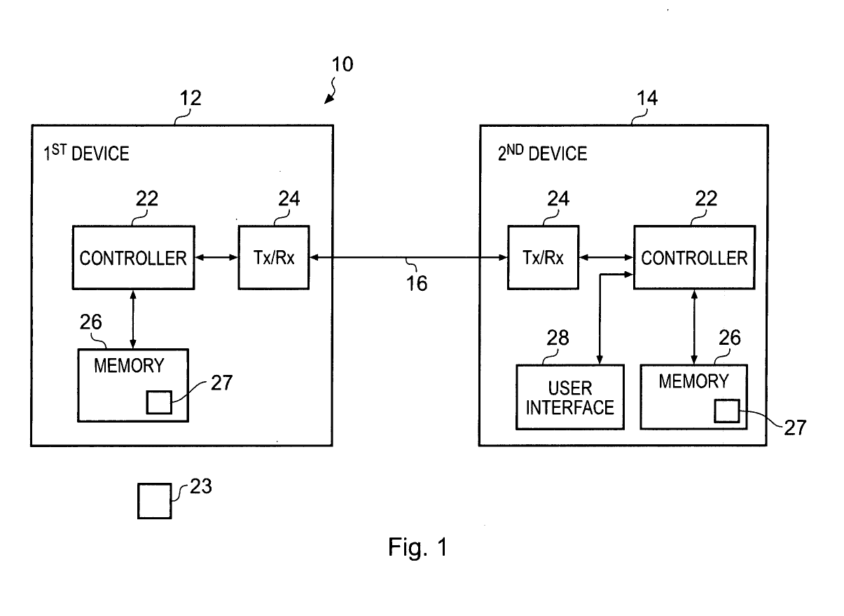

FIG. 1 illustrates a schematic diagram of one embodiment of a system 10 which is, in this embodiment, an OFDMA-TDMA system. In more detail, the system 10 includes a first electronic device 12 and a second electronic device 14 connected to one another via a link 16 (wired or wireless). The first and second electronic devices 12 & 14 may be any electronic devices within a network which are arranged to transmit and/or receive data.

The first and second electronic devices 12 & 14 may be portable telephones, such as mobile cellular telephones. Alternatively, the first and second electronic devices 12 & 14 may be personal digital assistants (PDA), laptop computers or personal computers which are provided with network adaptors and/or transceiver circuitry.

In this embodiment, the first electronic device 12 and the second electronic device 14 are in a cellular network and connected via a wireless link 16. The first electronic device 12 is a base transceiver station and the second electronic device 14 is a portable transceiver device. In other embodiments, the first electronic device 12 and the second electronic device 14 are in a personal area network (PAN) such as Bluetooth or WLAN and are portable transceiver devices.

As illustrated in FIG. 1, the first electronic device 12 includes a controller 22, a transceiver 24 and a memory 26. The second electronic device 14 includes a controller 22, a transceiver unit 24, a memory 26 and a user interface 28.

The controller 22 may be any suitable processor and is, in this embodiment, a microprocessor. The controller 22 is connected to read from and write to the memory 26. The memory 26 may be any suitable memory and may be, for example, permanent built-in memory such as flash memory or it may be a removable memory such as a hard disk, secure digital (SD) card or a micro-drive.

In the second electronic device 14, the controller 22 is also connected to a user interface 28 which enables a user to interact with the device. In the embodiment where the second electronic device 14 is a mobile cellular telephone, the user interface 28 includes a display, a microphone, a loud speaker and a user input device such as a keypad. These features are well known within the field of mobile cellular telephony and will consequently not be described in detail here.

The controller 22 is also connected to the transceiver 24 to transmit data to, and receive data from, the wireless link 16. The transceiver 24 is arranged to receive and modulate data from the controller 22 and then provide the modulated data to an antenna arrangement (not illustrated in the figures) for transmission to another electronic device via the link 16. The transceiver 24 is also arranged to receive and demodulate modulated data from the antenna arrangement and provide the demodulated data to the controller 22.

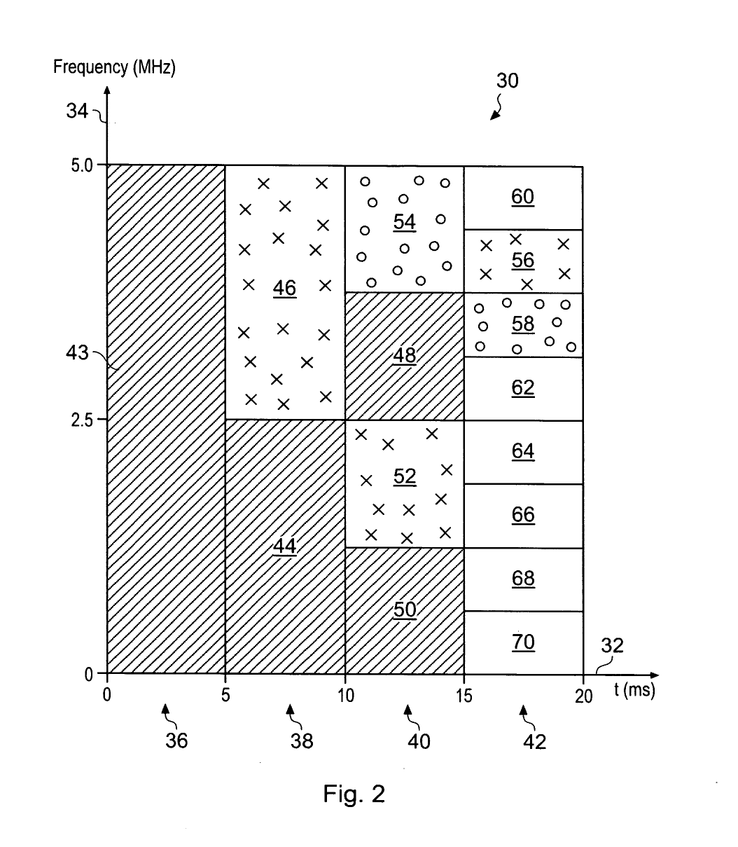

FIG. 2 illustrates a graph 30 of how frequency channels and time slots may be divided in an OFDMA-TDMA system. The graph 30 includes a horizontal axis 32 for time and a vertical axis 34 for frequency. The horizontal time axis 32 is divided into a plurality of time slots (of 5 ms width in this embodiment) in which data can be transferred between devices of the OFDMA-TDMA system 10. In a time slot, an electronic device may communicate with the network using one or more frequency bandwidths. The number and position of the frequency bandwidths allocated to each device may be changed in each time slot. Consequently, OFDMA-TDMA systems are efficient since they are able to utilise the frequency spectrum dynamically.

In this example, the graph 30 represents communication between the first electronic device 12, the second electronic device 14, a third electronic device and a fourth electronic device (not illustrated in FIG. 1 for clarity). The word ‘communication’ includes both the transmission of data to another device and the reception of data from another device. In a first time slot 36 (between 0 ms and 5 ms), the first electronic device 12 may use the whole of the radio frequency spectrum (between 0 MHz and 5 MHz—frequency band 43) to communicate with the second electronic device 14. In a second time slot 38 (between 5 ms and 10 ms), the first electronic device 12 may communicate with the second electronic device in a frequency band 44 and with the third electronic device in a frequency band 46. In a third time slot 40 (between 10 and 15 ms), the first electronic device 12 may communicate with the second electronic device 14 in frequency bands 48 and 50, with the third electronic device in a frequency band 52 and with the fourth electronic device in a frequency band 54. In a fourth time slot 42 (between 15 ms and 20 ms), the first electronic device 12 may communicate with the third electronic device in a frequency band 56 and with the fourth electronic device in a frequency band 58.

It should be noted that frequency bands 60, 62, 64, 66, 68, 70 are not used by the first electronic device 12 to communicate with one of the other electronic devices in the fourth time slot 42. In these frequency bands, the second electronic device 14, the third electronic device and the fourth electronic device may communicate with one another. Alternatively, at least one of the frequency bands 60, 62, 64, 66, 68, 70 may be unused by the electronic devices.

Therefore, it is clear from the above example that one of the advantages of a system, such as an OFDMA-TDMA system is that it enables efficient usage of the available frequency spectrum by the electronic devices.

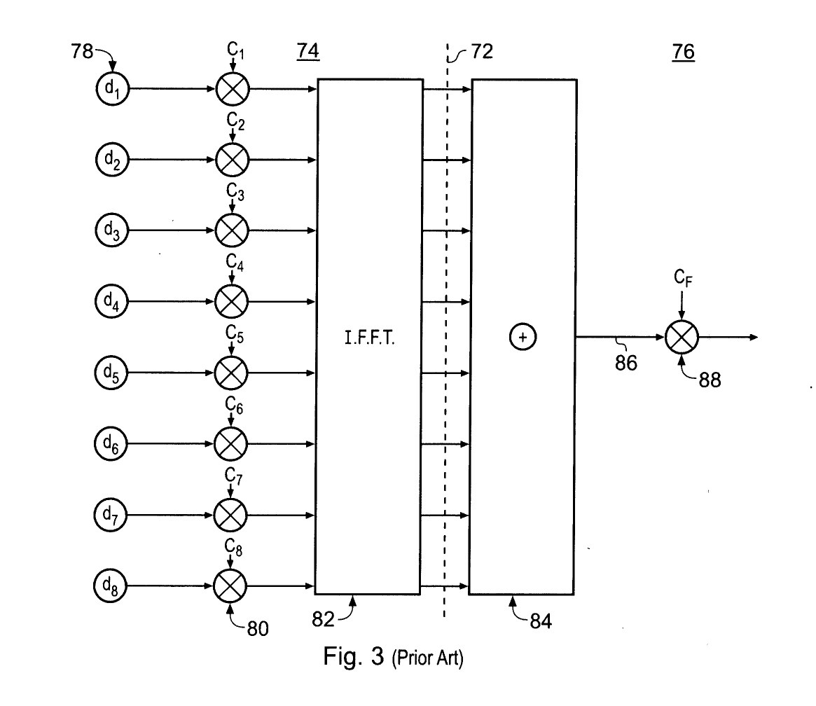

FIG. 3 illustrates a flow diagram of data at a transmitter in a system, such as an OFDMA-TDMA system, according to the prior art. The flow diagram is divided by a dotted line 72 into a first portion 74 and a second portion 76. The first portion 74 includes functions which are performed by the controller 22 whereas the second portion 76 includes functions which are performed by the transceiver 24. In the following description, the transmitter is the first electronic device 12 which is a base transceiver station.

Starting with the functions which are performed by the controller 22 in the first portion 74, the controller 22 receives third data at step 78. The third data may be any data which is to be transmitted to the second electronic device 14 via the wireless link 16. For example, the third data may be voice data, from another electronic device, which has been received by the first electronic device 12 for transmission to the second electronic device 14. In this example, the third data includes data items d₁ to d₈.

At step 80, each data item of the third data is modulated with a sub-carrier (c₁ to c₈) to produce second data. Each sub-carrier (c₁ to c₈) is orthogonal to each of the other sub-carriers. At step 82, an inverse fast Fourier transform is performed on each data item of the second data to convert each of the data items from the frequency domain to the time domain and thereby produce first data.

In the second portion 76 of the flow diagram, the transceiver 24 receives the first data and performs a summation on them at step 84 to produce a signal 86. At step 88, the signal 86 is modulated with a carrier wave c_{f} and is then provided to the antenna arrangement as a modulated signal for transmission to another electronic device via the cellular network 20 (or to the second electronic device 14 via the link 16).

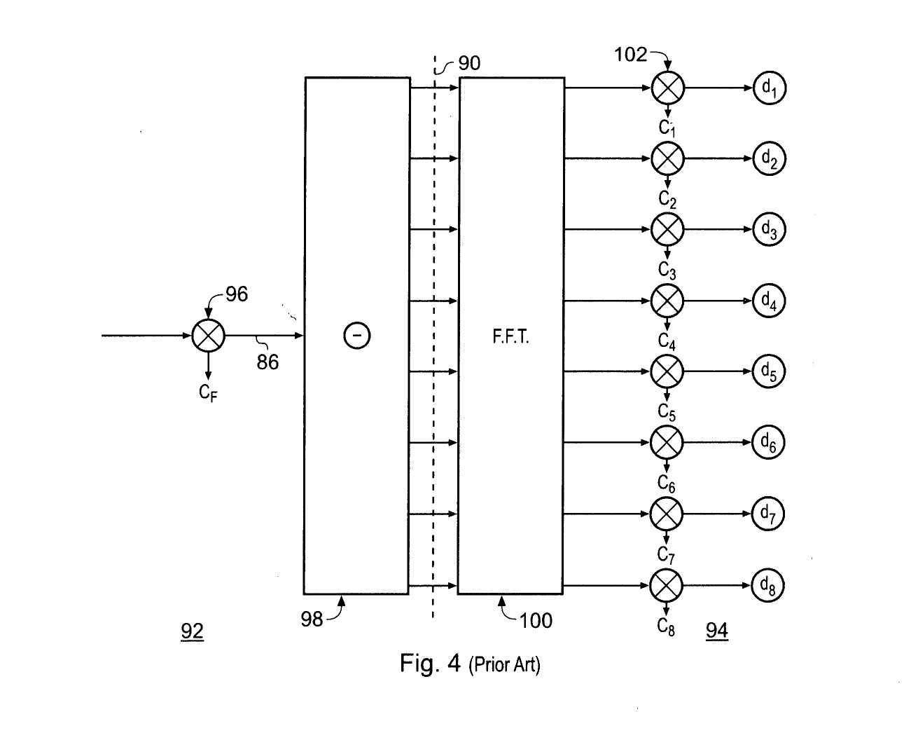

FIG. 4 illustrates a flow diagram of data at a receiver in a system, such as an OFDMA-TDMA system, according to the prior art. The flow diagram is divided by a dotted line 90 into a first portion 92 and a second portion 94. The first portion 92 includes functions which are performed by the transceiver 24 whereas the second portion 94 includes functions which are performed by the controller 22.

In the following example, the receiver is the second electronic device 14 (a portable electronic device) which is arranged to receive the modulated signal from the first electronic device described with reference to FIG. 3 above.

Starting with the functions which are performed by the transceiver 24 in the first portion 92, at step 96 the transceiver 24 receives the modulated signal from the first device 12 and demodulates it to produce the signal 86. At step 98 the transceiver 24 splits the signal 86 up to form the first data described above.

In the second portion of the flow diagram at step 100, the controller 22 receives the first data from the transceiver 24 and performs a fast Fourier transform on it to convert it from the time domain to the frequency domain and thereby produce second data. The controller 22 then demodulates the second data at step 102 to recover the third data (including data items d₁ to d₈) described above with reference to FIG. 3.

One problem associated with this method is that the receiving device has no knowledge of which sub-carriers it should fast Fourier transform.

Consequently, the controller 22 is required to fast Fourier transform all of the first data even if it does not contain any information for the receiving device.

For example, even if the first device 12 only transmits modulated data items d₁ and d₅ (modulated with sub-carriers c₁ and c₅ respectively for example) to the second device 14, the second device 14 still performs the same number of fast Fourier transforms on the received first data as if it had received first data corresponding to data items d₁ to d₈. This problem may result in inefficient power consumption since the controller 22 may have to perform a larger number of calculations than necessary.

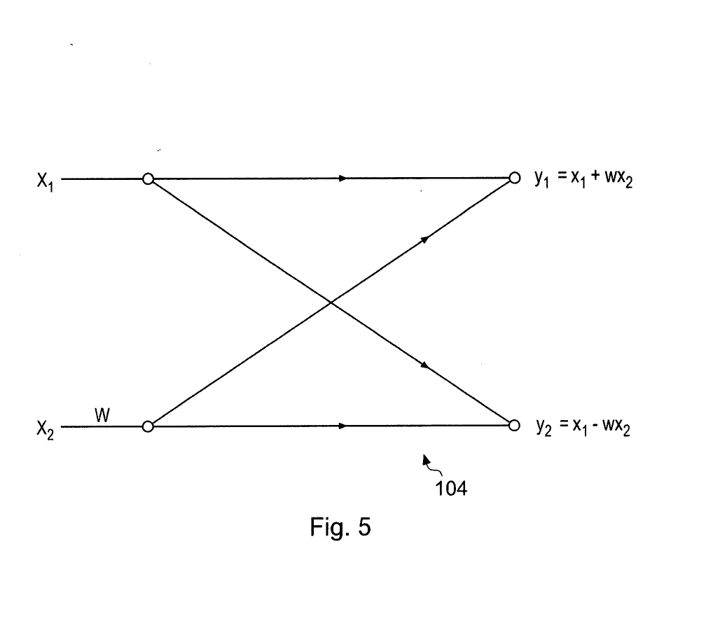

FIG. 5 illustrates a diagram of a ‘butterfly’ 104. A butterfly is a portion of a computation that combines the results of smaller discrete Fourier transforms into a larger discrete Fourier transform.

A butterfly 104 has a first input x₁, a second input x₂, a first possible output y₁ and a second possible output y₂. The butterfly 104 includes two possible ‘butterfly computations’. A butterfly computation includes a first input x₁, a second input x₂ and an output which is equal to a weighted sum of the first input x₁ and the second input x₂. For a first butterfly computation (y₁), the weighted sum is equal to the summation of the first input x₁ and the second input x₂ multiplied by a weighting factor +w. For a second butterfly computation (y₂), the weighted sum is equal to the summation of the second input x₂ multiplied by a weighting factor −w and the first input x₁.

FIG. 6 illustrates a schematic flow diagram of data at a receiver in a system according to one embodiment of the present invention. In the following example, the system is an OFDMA-TDMA system and the transmitting device is the first electronic device 12 (base transceiver station) and the receiving device is the second electronic device 14 (portable electronic device).

In this embodiment, the first electronic device 12 transmits third data, d₁ and d₅ only to the second electronic device 14. Prior to transmitting the third data, d₁ and d₅ to the second electronic device 14 however, the first electronic device 12 determines which sub-carriers are to be allocated to the communication channel 16 between the first electronic device 12 and the second electronic device 14 for the transmission of the third data. The first electronic device 12 determines which sub-carriers to allocate to the communication channel by using data obtained by measuring the channel condition and/or quality of service and/or data rate of each available channel between the first electronic device 12 and the second electronic device 14. The allocated sub-carriers are a subset of the available sub-carriers and in one embodiment, each sub-carrier of the subset is separated from an adjacent sub-carrier of the subset by substantially the same bandwidth. In one embodiment, the number of sub-carriers allocated to the communication channel is equal to a power of two.

In this embodiment, the first electronic device 12 determines that sub-carriers c₁ and c₅ are most suitable for use and allocates them to the communication channel. It should be noted that in this embodiment, the number of sub-carriers in the subset of sub-carriers is equal to a power of two. The first electronic device 12 then transmits this information 110 to the second electronic device 14 via a signalling channel. In this embodiment, the information 110 includes an indication of the first allocated sub-carrier (i.e. c₁ in this example) and the number of sub-carriers allocated to the channel (two in this example). The first electronic device 12 subsequently modulates the third data d₁ and d₅ with the sub-carriers c₁ and c₅ respectively and performs steps 82, 84 and 88 mentioned above with reference to FIG. 3.

The flow diagram illustrated in FIG. 6 is similar to the flow diagram illustrated in FIG. 4 and the same reference numerals are used for similar features. Starting with the functions which are performed by the transceiver 24 in the first portion 92, at step 96 the transceiver 24 receives the modulated signal from the first device 12 and demodulates it to produce the signal 106. At step 98 the transceiver 24 splits the signal 106 to form first data 107. The first data 107 may include data items which are destined for electronic devices other than the second electronic device 14.

In the second portion of the flow diagram at step 108, the controller 22 receives the information 110 and determines that the first allocated sub-carrier is c₁ and that the other allocated sub-carrier is c₅. The controller 22 also receives the first data 107 from the transceiver 24 and performs a plurality of butterfly computations on it to convert it from the time domain to the frequency domain and thereby produce second data 109. The butterfly computations used are a subset of the available butterfly computations and are selected using the received information 110 regarding the allocated sub-carriers. The controller 22 then demodulates the second data at step 102 to recover the third data, d₁ and d₅.

Embodiments of the present invention provide an advantage in that they may reduce power consumption at the receiving device. This advantage arises from the fact that the controller 22 at the receiving device may perform only a subset of butterfly computations of the available butterfly computations.

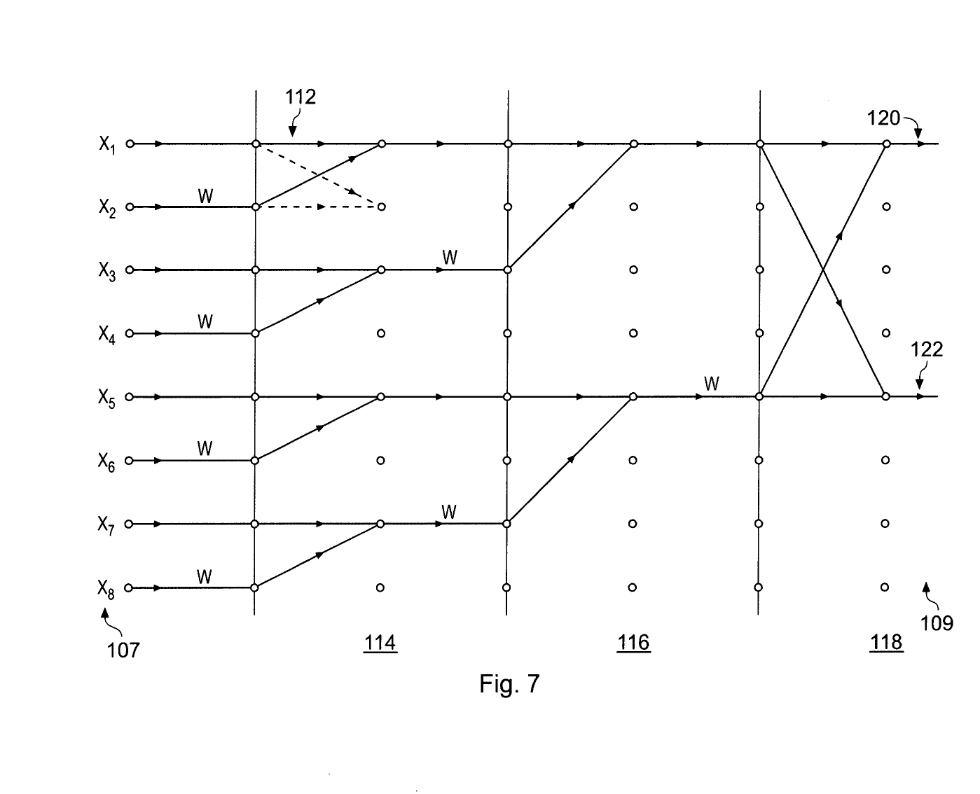

FIG. 7 illustrates a plurality of butterfly computations performed at a receiver in a system, such as an OFDMA system, according to a first embodiment of the present invention. In more detail, FIG. 7 illustrates the butterfly computations which are used by the controller 22 of the second electronic device 14 in step 108 of FIG. 6. Generally, the butterfly computations not used by the controller 22 are not illustrated in FIG. 7 to maintain clarity.

The butterfly computations available for use by the controller 22 are sequentially arranged into a first layer 114, a second layer 116 and a third layer 118. The first layer 114, the second layer 116 and the third layer 118 are parallel to one another and arranged so that the output from the first layer 114 is the input to the second layer 116 and the output of the second layer 116 is the input to the third layer 118. The input to the first layer 114 is the first data 107 and the output from the third layer 118 is the second data 109.

The selection of butterfly computations used in each layer of the sequence of layers by the controller 22 is dependent upon the received information 110. In this embodiment, the received information 110 informs the controller 22 of the second electronic device 14 that the allocated sub-carriers are c₁ and c₅. The controller 22 of the second electronic device 14 uses the information regarding the allocated sub-carriers to perform only the butterfly computations necessary to produce the required second data 109. In this embodiment, the second data includes data items which correspond to the data items d₁ and d₅ modulated with the sub-carriers c₁ and c₅ respectively.

In the first layer 114, the controller 22 receives the first data 107 from the transceiver 24 as eight inputs x₁ to x₈. Using the received information 110 regarding the allocated sub-carriers, the controller 22 performs four butterfly computations from the available eight butterfly computations. For example, in butterfly 112 the butterfly computation of x₁+wx₂ is used (drawn in a solid line) whereas the butterfly computation of x₁−wx₂ is not used (drawn in a broken line). The output of the first layer 114 is (x₁+wx₂), (x₃+wx₄), (x₅+wx₆) and (x₇+wx₈).

In the second layer 116, the controller 22 performs two butterfly computations on the four outputs from the first layer 114 to produce two outputs [(x₁+wx₂)+w(x₃+wx₄)] and [(x₅+wx₆)+w(x₇+wx₈)]. In the third layer 118, the controller 22 performs two butterfly computations on the two outputs from the second layer 116 to produce a first output 120 equal to {[(x₁+wx₂)+(x₃+wx₄)]+w[(x₅+wx₆)+(x₇+wx₈)]} and a second output 122 equal to {[(x₁+wx₂)+(x₃+wx₄)] w[(x₅+wx₆)+(x₇+wx₈)]}.

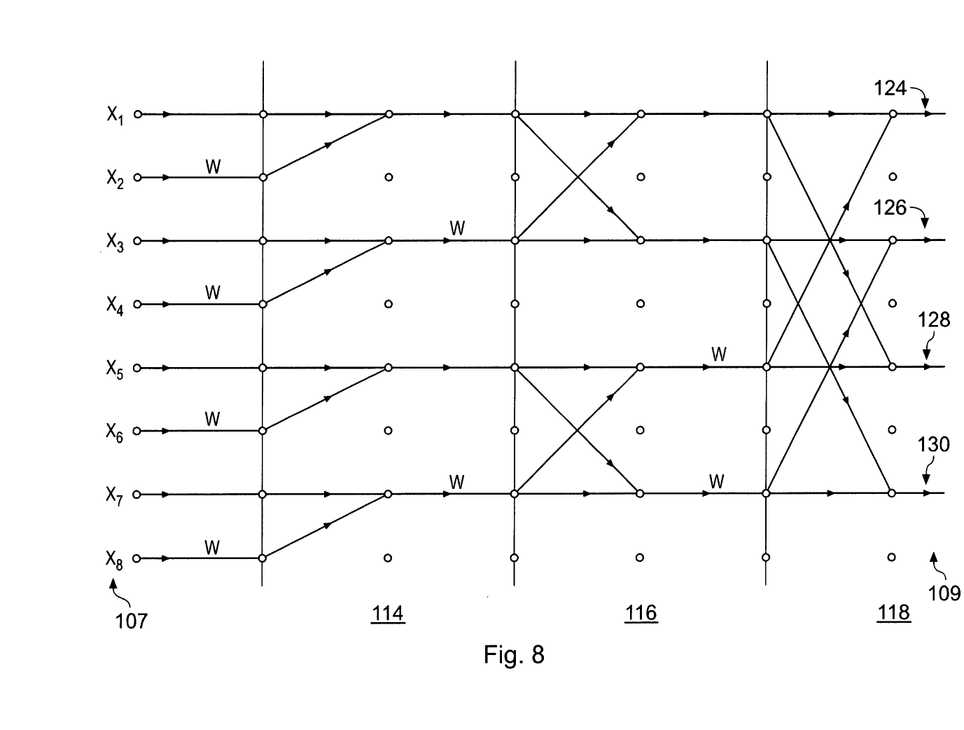

FIG. 8 illustrates a plurality of butterfly computations performed at a receiver in a system, such as an OFDMA-TDMA system, according to a second embodiment of the present invention. In this embodiment, the subset of sub-carriers allocated to the second electronic device 14 includes c₁, c₃, c₅ and c₇. It should be noted that the number of sub-carriers is equal to a power of two and that each sub-carrier of the subset is separated from an adjacent sub-carrier of the subset by substantially the same bandwidth. The data transmitted from the first electronic device 12 to the second electronic device 14 includes data items d₁, d₃, d₅ and d₇ which are modulated with the above mentioned subset of sub-carriers.

In the first layer 114, the controller 22 receives the first data 107 from the transceiver 24 as eight inputs x₁ to x₈. Using the received information regarding the allocated sub-carriers, the controller 22 performs four butterfly computations from the available eight butterfly computations. The output of the first layer 114 is (x₁+wx₂), (x₃+wx₄), (x₅+wx₆) and (x₇+wx₈).

In the second layer 116, the controller 22 performs four butterfly computations on the four outputs from the first layer 114 to produce four outputs [(x₁+wx₂)+w(x₃+wx₄)], [(x₁+wx₂)−w(x₃+wx₄)], [(x₅+wx₆)+w(x₇+wx₈)] and [(x₅+wx₆)−w(x₇+wx₈)].

In the third layer 118, the controller 22 performs four butterfly computations on the four outputs from the second layer 116 to produce a first output 124 equal to {[(x₁+wx₂)+(x₃+wx₄)]+w[(x₅+wx₆)+(x₇+wx₈)]}, a second output 126 equal to {[(x₁+wx₂)— (x₃+wx₄)]+w[(x₅+wx₆)— (x₇+wx₈)]} a third output 128 equal to {[(x₁+wx₂)+(x₃+wx₄)]−w[(x₅+wx₆)+(x₇+wx₈)]} and a fourth output 130 equal to {[(x₁+wx₂)— (x₃+wx₄)]−w[(x₅+wx₆)— (x₇+wx₈)]}.

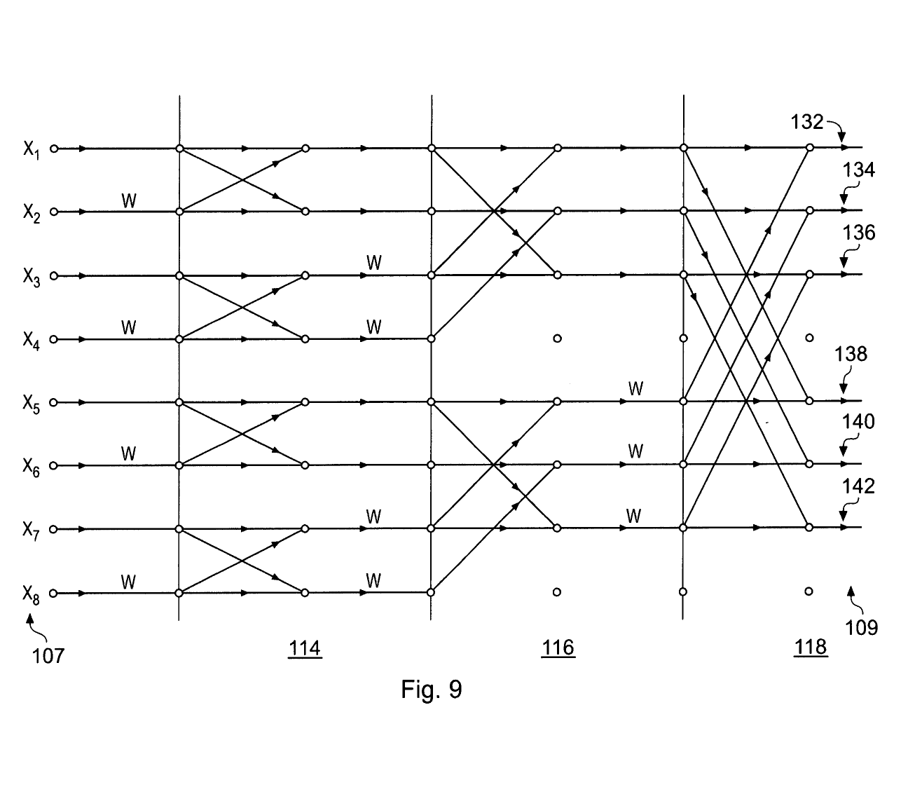

FIG. 9 illustrates a plurality of butterfly computations performed at a receiver in a system, such as an OFDMA-TDMA system, according to a third embodiment of the present invention. In this embodiment, the subset of sub-carriers allocated to the second electronic device 14 includes c₁, c₂, c₃, c₅, c₆ and c₇. It should be noted that the number of sub-carriers is equal to a power of two. The data transmitted from the first electronic device 12 to the second electronic device 14 includes data items d₁, d₂, d₃, d₅, d₆ and d₇ which are modulated with the above mentioned subset of sub-carriers.

In the first layer 114, the controller 22 receives the first data 107 from the transceiver 24 as eight inputs x₁ to x₈. Using the received information regarding the allocated sub-carriers, the controller 22 performs eight butterfly computations. The output of the first layer 114 is (x₁+wx₂), (x₁−wx₂), (x₃+wx₄), (x₃−wx₄), (x₅+wx₆), (x₅−wx₆), (x₇+wx₈) and (x₇−wx₈).

In the second layer 116, the controller 22 performs six butterfly computations on the eight outputs from the first layer 114 to produce six outputs [(x₁+wx₂)+w(x₃+wx₄)], [(x₁−wx₂)+w(x₃−wx₄)], [(x₁+wx₂)−w(x₃+wx₄)], [(x₅+wx₆)+w(x₇+wx₈)], [(x₅−wx₆)+w(x₇−wx₈)] and [(x₅+wx₆)—w(x₇+wx₈)].

In the third layer 118, the controller 22 performs six butterfly computations on the six outputs from the second layer 116 to produce a first output 132 equal to {[(x₁+wx₂)+(x₃+wx₄)]+w[(x₅+wx₆)+(x₇+wx₈)]}, a second output 134 equal to {[(x₁−wx₂)+(x₃−wx₄)]+w[(x₅−wx₆)+(x₇−wx₈)]}, a third output 136 equal to {[(x₁+wx₂)— (x₃+wx₄)]+w[(x₅+wx₆)— (x₇+wx₈)]}, a fourth output 138 equal to {{[(x₁+wx₂)+(x₃+wx₄)]−w[(x₅+wx₆)+(x₇+wx₈)]}, a fifth output 140 equal to {[(x₁−wx₂)+(x₃−wx₄)]−w[(x₅−wx₆)+(x₇−wx₈)]} and a sixth output 142 equal to {[(x₁+wx₂)— (x₃+wx₄)]−w[(x₅+wx₆)— (x₇+wx₈)]}.

With reference to FIG. 1, in embodiments of the present invention the memory 26 of each electronic device 12, 14, 16, 18 stores computer program instructions 27 that control the operation of the electronic devices 12, 14, 16, 18 when loaded into the controller 22. The computer program instructions 27 provide the logic and routines that enables the electronic devices 12, 14, 16, 18 to perform the methods described above and those illustrated in FIGS. 6 to 9.

The computer program instructions provide: means 22 for converting first data from the time domain to the frequency domain using butterfly computations to produce second data, wherein the butterfly computations used are a subset of the available butterfly computations and are selected using the received information.

The computer program instructions may arrive at the electronic devices 12, 14, 16, 18 via an electromagnetic carrier signal 21 or be copied from a physical entity 23 such as a computer program product, a memory device or a record medium such as a CD-ROM or DVD.

Although embodiments of the present invention have been described in the preceding paragraphs with reference to various examples, it should be appreciated that modifications to the examples given can be made without departing from the scope of the invention as claimed. For example, in one embodiment, the second electronic device 14 (portable electronic device) is the transmitting device and the first electronic device (12) is the receiving device and performs the methods illustrated in FIGS. 6 to 9.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method of transferring data from a first device to a second device, the method comprising:
receiving information at the second device; and
converting first data, from the first device, from the time domain to the frequency domain using butterfly computations to produce second data,
wherein the butterfly computations used are a subset of the available butterfly computations and are selected using the received information.

2. A method as claimed in claim 1, wherein a butterfly computation includes a first input, a second input and an output, the output being equal to a weighted sum of the first input and the second input.

3. A method as claimed in claim 2, wherein the weighted sum is equal to the addition of the second input multiplied by a negative weighting factor to the first input.

4. A method as claimed in claim 2, wherein the weighted sum is equal to the addition of the second input multiplied by a positive weighting factor to the first input.

5. A method as claimed in claim 2, wherein each of the selected butterfly computations has a different combination of first input, second input and weighting factor.

6. A method as claimed in claim 1, wherein the available butterfly computations are arranged into a plurality of parallel layers arranged sequentially, each layer including a plurality of butterfly computations.

7. A method as claimed in claim 6, wherein the first input and the second input of a butterfly computation in a layer are each arranged to receive outputs from different butterfly computations in a preceding layer in the sequence of layers.

8. A method as claimed in claim 6, wherein the inputs to the butterfly computations in the initial layer of the sequence of layers are the first data.

9. A method as claimed in claim 6, wherein the outputs to the butterfly computations in the final layer of the sequence of layers are the second data.

10. A method as claimed in claim 6, wherein the selection of butterfly computations used in each layer of the sequence of layers is dependent on the received information.

11. A method as claimed in claim 1, wherein the received information is for defining a subset of sub-carriers, within a plurality of sub-carriers, which are allocated to a communication channel between the first device and the second device

12. A method as claimed in claim 11, wherein the number of sub-carriers in the subset of sub-carriers is equal to a power of two.

13. A method as claimed in claim 11, wherein each sub-carrier of the subset is separated from an adjacent sub-carrier of the subset by substantially the same bandwidth.

14. A method as claimed in claim 11, wherein the number of data items in the second data is equal to the number of sub-carriers in the allocated subset of sub-carriers.

15. A method as claimed in claim 11, wherein the first device determines the subset of sub-carriers and transmits the information for defining the subset of sub-carriers to the second device.

16. A method as claimed in claim 1, wherein the conversion of the first data from the time domain to the frequency domain occurs at the second device.

17. A device comprising:
a receiver for receiving information; and
a processor for converting first data, from a further device, from the time domain to the frequency domain using butterfly computations to produce second data,
wherein the butterfly computations used are a subset of the available butterfly computations and are selected using the received information.

18. A device as claimed in claim 17, wherein a butterfly computation includes a first input, a second input and an output, the output being equal to a weighted sum of the first input and the second input.

19. A device as claimed in claim 18, wherein the weighted sum is equal to the addition of the second input multiplied by a negative weighting factor to the first input.

20. A device as claimed in claim 18, wherein the weighted sum is equal to the addition of the second input multiplied by a positive weighting factor to the first input.

21. A device as claimed in claim 18, wherein each of the selected butterfly computations has a different combination of first input, second input and weighting factor.

22. A device as claimed in claim 17, wherein the available butterfly computations are arranged into a plurality of parallel layers arranged sequentially, each layer including a plurality of butterfly computations.

23. A device as claimed in claim 22, wherein the first input and the second input of a butterfly computation in a layer are each arranged to receive outputs from different butterfly computations in a preceding layer in the sequence of layers.

24. A device as claimed in claim 22, wherein the inputs to the butterfly computations in the initial layer of the sequence of layers are the first data.

25. A device as claimed in claim 22, wherein the outputs to the butterfly computations in the final layer of the sequence of layers are the second data.

26. A device as claimed in claim 22, wherein the selection of butterfly computations used in each layer of the sequence of layers is dependent on the received information.

27. A device as claimed in claim 17, wherein the received information is for defining a subset of sub-carriers, within a plurality of sub-carriers, which are allocated to a communication channel between the device and the further device

28. A device as claimed in claim 27, wherein the number of sub-carriers in the subset of sub-carriers is equal to a power of two.

29. A device as claimed in claim 27, wherein each sub-carrier of the subset is separated from an adjacent sub-carrier of the subset by substantially the same bandwidth.

30. A device as claimed in claim 27, wherein the number of data items in the second data is equal to the number of sub-carriers in the allocated subset of sub-carriers.

31. A device as claimed in claim 27, wherein the further device determines the subset of sub-carriers and transmits the information for defining the subset of sub-carriers to the device.

32. A system comprising:
a first device for transmitting information;
a second device for receiving the information, wherein the second device is arranged to convert first data, from the first device, from the time domain to the frequency domain using butterfly computations to produce second data, wherein the butterfly computations used are a subset of the available butterfly computations and are selected using the received information.

33. A computer program comprising program instructions for converting data from the time domain to the frequency domain and comprising means for converting first data from the time domain to the frequency domain using butterfly computations to produce second data, wherein the butterfly computations used are a subset of the available butterfly computations and are selected using received information.

34. A physical entity embodying the computer program as claimed in claim 33.

35. An electromagnetic carrier signal carrying the computer program as claimed in claim 33.

36. A computer program comprising program instructions for causing a computer to perform the method of claim 1.

37. A computer program comprising program instructions which, when loaded into a computer, constitute the processor of claim 17.
